(19) United States
(12) Patent Application Publication
(10) Pub. No.: US 2004/0243820 A1
(43) Pub. Date: Dec. 2, 2004

(54) Information-embedding apparatus and method, tampering-detecting apparatus and method, and recording medium

(76) Inventors: Kenichi Noridomi, Fukuoka (JP); Hisashi Inoue, Fukuoka (JP); Masataka Ejima, Iizuka (JP)

Correspondence Address: WENDEROTH, LIND & PONACK, L.L.P., 2033 K STREET N. W., SUITE 800, WASHINGTON, DC, 20006-1021, US

(21) Appl. No.: 10/831,200

(22) Filed: Apr. 26, 2004

(30) Foreign Application Priority Data
May 14, 2003 (JP) 2003-135800

(51) Int. Cl. H04L 9/00

(52) U.S. Cl. 713/194

(57) ABSTRACT

An inherent information-generating unit is operable to generate inherent information inherent to each frame image that forms part of moving image data. An information-embedding unit is operable to embed inherent information on a specific frame image as tampering-detecting information into a different frame image in which the inherent information is to be embedded. The specific frame image is temporally separated in position from the different frame image.

### BACKGROUND OF THE INVENTION

1. Field of the Invention

The present invention relates to an information-embedding apparatus and method operable to embed information into moving image data to detect tampering from the moving image data.

2. Description of the Related Art

In the past, an analog image-processing art has been used to record and replay images. A recoding medium includes, e.g., a spool of film and a pack of VHS videotape. In case the data is maliciously altered in the course of the analog image processing as discussed above, unusual traces remain attached to the medium at splicing sections thereof. Therefore, it is said that those skilled in the art easily can determine whether moving images have been tampered with. Consequently, when those skilled in the art judges that a pack of VHS videotape remains intact, it would be verified that the VHS videotape is true.

The analog image-processing art is now being withdrawn in stages from service. Instead, a digital image input unit such as a digital camera and a digital recorder such as an HDD recorder have become popular rapidly.

The use of commercially available image-processing software is responsible for easy and simple tampering (e.g., editing and modification) of digital moving image data. What is worse is that the digital moving image data can dishonestly be modified without leaving any trace at all. Consequently, even for those skilled in the art, it is practically impossible to recognize whether the digital moving image data has been tampered with.

The digital moving image data has come into service in the field of, e.g., a surveillance recording system as well. Accordingly, there has been a continuing need for an established art to check tampering in the digital moving image data.

The digital moving image data includes data and header portions. The data portion is constructed to temporally align plural frame images with each other in sequence. The header portion retains information on the data portion. The temporal axis, on which the frame images are temporally positioned in order, can be either one temporal axis to replay the frame images or another to store the frame images in a recording medium such as a hard disc, a spool of tape, and a memory. The terms “temporal axis” and “temporally” as set forth herein refer to either one of the above two definitions.

The term “frame image” as set out herein can be either a frame image in frame structure-based moving image data or that in field structure-based moving image data.

The moving image data tampering as addressed herein is broadly divided into two categories as given below.

First tampering: the frame image itself is maliciously modified. For example, it may be assumed that a criminal erases his or her self-images (partial images in the frame images) from the frame images and/or replaces the criminal's self-images by other images to conceal his or her crime because the criminal's self-images have taken pictures of the crime.

Second tampering: the way in which the data portion (of the moving image data) has plural frame images temporally aligned with each other in sequence is dishonestly modified. For example, it may be assumed that a criminal collectively removes all disadvantageous frame images from the moving image data because those frame images have taken scenes of criminal's behavior, and that the criminal collectively replaces the removed frame images by other frame images in which no scenes of the criminal's behavior are photographed.

It is understood that both of the first and the second tampering might be practiced. Therefore, the required tampering-detecting art must cope with the second tampering as well as the first tampering in order to verify that the moving image data is true without being tampered with.

There has heretofore been known a digital watermark-based tampering-detecting method. A digital watermark is an art operable to embed digital information into the digital moving image data in such a manner as to preclude human eyes from perceiving the embedded digital information.

A method for verifying whether the digital image data has been tampered with is disclosed by, e.g., published Japanese Patent Application Laid-Open No. 2002-271609, which is hereinafter called patent reference No. 1.

The tampering-verifying method as just mentioned is now described with reference to FIG. 15. FIG. 15 is a block diagram illustrating a prior art tampering-verifying apparatus.

In FIG. 15, a control unit 804 provides control over elements 801 to 803 and elements 805 to 813. Information on a key enters a key input unit 801. A pseudo-random number-generating unit 810 generates pseudo-random numbers. Image data enters an image data input unit 809. A memory 812 saves the image data.

A block-dividing unit 807 divides the image data in the memory 812 into plural blocks, each of which has a given size. A frequency-transforming unit 802 transforms the divided image data into frequency space. A tampering verifying data-generating unit 811 generates tampering-verifying data based on the generated frequency components. A tampering verifying data-embedding unit 803 embeds the generated tampering-verifying data into some of the generated frequency components. This tampering-verifying system checks for dishonestly altered data in accordance with the tampering-verifying data. A Huffman-encoding unit 808 performs the Huffman-encoding of the frequency components having the tampering-verifying data embedded therein.

Another tampering-detecting method as discussed below is disclosed by published Japanese Patent Application Laid-Open No. (HEI) 11-341268, which is hereinafter called patent reference No. 2. Digital signature bits of a digital image hash function are embedded into a digital image frequency function, thereby embedding a digital watermark into a digital image. The brittle digital watermark embedded in the digital image is extracted from the digital image. The digital image hash function is calculated in a manner similar to the way in which the digital image hash function is calculated when the digital watermark has been embedded into the digital image. It is verified using a public key whether the extracted watermark is a valid signature of a hash value. As a result, it is detected whether the digital image has been altered maliciously. The presence of the valid signature determines that the digital image remains intact, or otherwise it is determined that the digital image has been tampered with.

However, the prior art is disadvantageous in that a digital watermark for use in detecting tampered data cannot be embedded into a predictive coded image when the moving image data conforms to a format, such as MPEG, that uses inter-frame image prediction.

For example, when the moving image data has substantially motionless scenes recorded therein, which are very close to still images, there is virtually no difference between frame images. It follows that nearly few encoded blocks are present in the predictive coded image (P- or B-picture in MPEG format). This means that no information is embeddable because both of patent references No. 1 and No. 2 presuppose the presence of the encoded block in which the digital watermark is to be embedded. As a result, the prior art is impossible to detect the tampering from the predictive coded image.

The prior art is under-qualified for the tampering detection because the prior art can deal with the first tampering, but not with the second tampering.

As a countermeasure to handle the second tampering, an art operable to record and display time visibly in the frame images may be used. However, the countermeasure must visually examine every single piece of the displayed time to check for maliciously altered data. This system requires laborious operation with a great deal of effort when lengthy moving image data must be checked. Consequently, this is impractical.

What is more important is that injustices cannot be uncovered when a person who intends to dishonestly alter the data prepares frame images having the displayed time added thereto to join the flats. This disadvantage results in reduced reliability of the moving image data. In conclusion, the prior art is insufficient to reveal the tampering of moving image data.

### OBJECTS AND SUMMARY OF THE INVENTION

In view of the above, a first object of the present invention is to provide an art operable to detect temporal tampering from digital moving image data.

A second object of the present invention is to provide an art operable to detect the tampering of a predictive coded image itself.

A first aspect of the present invention provides an information-embedding apparatus operable to embed information into moving image data that includes a data portion and a header portion. The data portion is formed to temporally align plural frame images with each other in sequence. The header portion is designed to retain information on the data portion. The information-embedding apparatus comprises a sequence information input unit operable to generate sequence information on the plural frame images, and an information-embedding unit operable to embed the sequence information generated by the sequence information input unit into the moving image data over the plural frame images in such a manner as to render the sequence information invisible.

A second aspect of the present invention provides a tampering-detecting apparatus operable to check for tampering in moving image data that includes a data portion and a header portion. The data portion is formed to temporally align plural frame images with each other in sequence. The header portion is designed to retain information on the data portion. The tampering-detecting apparatus comprises an input unit operable to receive the moving image data having sequence information embedded therein, a detection unit operable to detect the sequence information from the moving image data received by the input unit, and a tampering-determining unit operable to determine, based on the sequence information detected by the detection unit, whether the moving image data has been tampered with.

According to the above two kinds of structure, the sequence information makes it feasible to automatically detect temporal tampering. The sequence information can be protected against a malicious rewrite because the moving image data has the sequence information embedded therein over the frame images in such a manner as to render the sequence information invisible.

A third aspect of the present invention provides an information-embedding apparatus as defined in the first aspect of the present invention, in which the information-embedding unit is operable to embed the sequence information as a digital watermark into the data portion.

The above structure allows the sequence information to be taken out of the frame images, and makes for less degradation in image quality of each of the frame images. The above structure avoids overlapping the sequence information over the frame images at an important partial image portion thereof such as, e.g., a partial image focusing on a criminal's face. As a result, the important partial image portion is prevented from being rendered obscure.

A fourth aspect of the present invention provides an information-embedding apparatus as defined in the first aspect of the present invention, in which the information-embedding unit is operable to embed the sequence information into the header portion.

The above structure allows the sequence information to be embedded into the moving image data without the frame images being edited or modified at all.

A fifth aspect of the present invention provides an information-embedding apparatus as defined in the first aspect of the present invention, in which the sequence information refers to numbers that show the sequence of the plural frame images.

A sixth aspect of the present invention provides a tampering-detecting apparatus as defined in the second aspect of the present invention, in which the sequence information refers to numbers that show the sequence of the plural frame images.

According to the above two kinds of structure, the use of the numbers makes for easy definition and interpretation of the sequence.

A seventh aspect of the present invention provides a tampering-detecting apparatus as defined in the second aspect of the present invention, in which the tampering-determining unit is operable to determine that the moving image data has been tampered with, when the plural frame images are changed in sequence, and when one or more frame images are removed or added to the plural frame images.

The above structure makes it feasible to detect a variety of temporal tampering.

An eighth aspect of the present invention provides an information-embedding apparatus operable to embed information into moving image data that includes a data portion and a header portion. The data portion is formed to temporally align plural frame images with each other in sequence. The header portion is designed to retain information on the data portion. The information-embedding apparatus comprises an inherent information-generating unit operable to generate inherent information on a first frame image among the plural frame images, in which the first frame image is temporally aligned in a given relationship with a second frame image among the plural frame images, and which the first frame image is a single or multiple frame images among the plural frame images, and the single or multiple frame images are different from the second frame image, and an information-embedding unit operable to embed the inherent information generated by the inherent information-generating unit into the second frame image.

A ninth aspect of the present invention provides a tampering-detecting apparatus operable to check for tampering in moving image data that includes a data portion and a header portion. The data portion is formed to temporally align plural frame images with each other in sequence. The header portion is designed to retain information on the data portion. The tampering-detecting apparatus comprises an input unit operable to receive the moving image data having sequence information embedded therein, an inherent information-generating unit operable to detect, from the moving image data received by the input unit, inherent information embedded in a second frame image among the plural frame images, thereby providing first inherent information, the inherent information-generating unit operable to generate inherent information on a first frame image among the plural frame images, thereby providing second inherent information, in which the first frame image is temporally aligned in a given relationship with the second frame image, and which the first frame image is a single or multiple frame images among the plural frame images, and the single or multiple frame images are different from the second frame image, a comparison unit operable to compare the first inherent information with the second inherent information, and a tampering-determining unit operable to determine, based on results from a comparison made by the comparison unit, whether the moving image data has been tampered with.

The inherent information used in the above two kinds of structure allows a specific frame image to be correlated with a different frame image. When the correlation is cut off, then it can be determined that the moving image data has temporally been tampered with. When the frame images themselves have maliciously been modified, then the correlation is cut off. This means that the first tampering as well as the second tampering can be coped with.

A tenth aspect of the present invention provides an information-embedding apparatus as defined in the eighth aspect of the present invention, in which the inherent information is a hash value related to the first frame image.

The above structure allows the inherent information to be properly expressed using the hash value.

An eleventh aspect of the present invention provides an information-embedding apparatus as defined in the eighth aspect of the present invention, in which the first frame image is temporally positioned next to the second frame image.

The above structure correlates neighboring frame images with one another to cope with temporal tampering.

A twelfth aspect of the present invention provides an information-embedding apparatus as defined in the eighth aspect of the present invention, in which the moving image data is MPEG-compressed moving image data, the second frame image is an intra-coded image, and the first frame image is a single or multiple predictive coded images.

The above structure can deal with a predictive coded image having a small amount of data.

A thirteenth aspect of the present invention provides an information-embedding apparatus as defined in the twelfth aspect of the present invention, in which the intra-coded image and the predictive coded images belong to a GOP (group of pictures).

The above structure can perform batch processing using the correlation.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram illustrating an information-embedding apparatus according to a first embodiment;

FIG. 2 is a flowchart illustrating behaviors of the information-embedding apparatus according to the first embodiment;

FIG. 3 is a descriptive illustration showing how information is embedded in accordance with the first embodiment;

FIG. 4 is a descriptive illustration showing a relationship between tampering-detecting information and blocks in which the tampering-detecting information is embedded in accordance with the first embodiment;

FIG. 5 is a descriptive illustration showing one of the blocks in which the tampering-detecting information is embedded in accordance with the first embodiment;

FIG. 6 is a block diagram illustrating a tampering-detecting apparatus according to a second embodiment;

FIG. 7 is a flowchart illustrating behaviors of the tampering-detecting apparatus according to the second embodiment;

FIG. 8 is a block diagram illustrating a system comprising a storage unit and storage mediums according to the first and second embodiments;

FIG. 9 is a descriptive illustration showing an information-embedding mode and a tampering-detecting mode according to a third embodiment;

FIG. 10 is a descriptive illustration showing an information-embedding mode and a tampering-detecting mode according to a fourth embodiment;

FIG. 11 is a descriptive illustration showing an information-embedding mode according to a fifth embodiment;

FIG. 12 is a descriptive illustration showing a tampering-detecting mode according to the fifth embodiment;

FIG. 13 is a descriptive illustration showing an information-embedding mode according to a sixth embodiment;

FIG. 14 is a descriptive illustration showing a tampering-detecting mode according to the sixth embodiment; and

FIG. 15 is a block diagram illustrating a prior art tampering-detecting apparatus.

### DETAILED DESCRIPTION OF THE PREFERRED EMBODIMENTS

Embodiments of the present invention are now described with reference to the accompanying drawings.

### FIRST EMBODIMENT

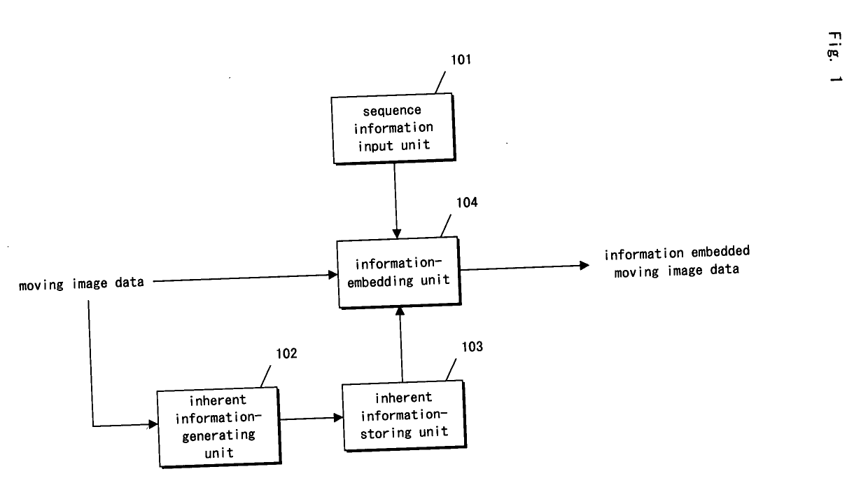

FIG. 1 is a block diagram illustrating an information-embedding apparatus according to a first embodiment of the present embodiment.

As illustrated in FIG. 1, the information-embedding apparatus according to the present embodiment comprises a sequence information input unit 101, an inherent information-generating unit 102, an inherent information-storing unit 103, and an information-embedding unit 104.

Referring to FIG. 10, moving image data is shown including a data portion 20 and a header portion 10. The data portion 20 is constructed to temporally align plural frame images “F1” to “F5” with each other in sequence. The header portion 10 stores information on the data portion 20.

In FIG. 1, the sequence information input unit 101 is operable to generate sequence information on frame images “F1” to “F5”. The information-embedding unit 104 is operable to embed the generated sequence information into the moving image data over frame images “F1” to “F5” in such a manner as to avoid visibly perceiving the embedded sequence information.

The information-embedding unit 104 according to the present embodiment is operable to either embed the sequence information as a digital watermark into each of the plural frame images or embed the sequence information into the header portion 10 at an extension area 10a thereof. The sequence information according to the present embodiment refers to the sequence number of frame images “F1” to “F5”.

The inherent information-generating unit 102 is operable to generate inherent information on either a single or multiple frame images among frame images “F1” to “F5”. The single or multiple frame images are temporally aligned in a given relationship with a specific frame image among frame images “F1” to “F5”. The single or multiple frame images differ from the specific frame image. The inherent information-storing unit 103 is operable to store the generated inherent information, and further to feed the stored inherent information into the information-embedding unit 104. The information-embedding unit 104 is operable to embed the stored inherent information into the specific frame image.

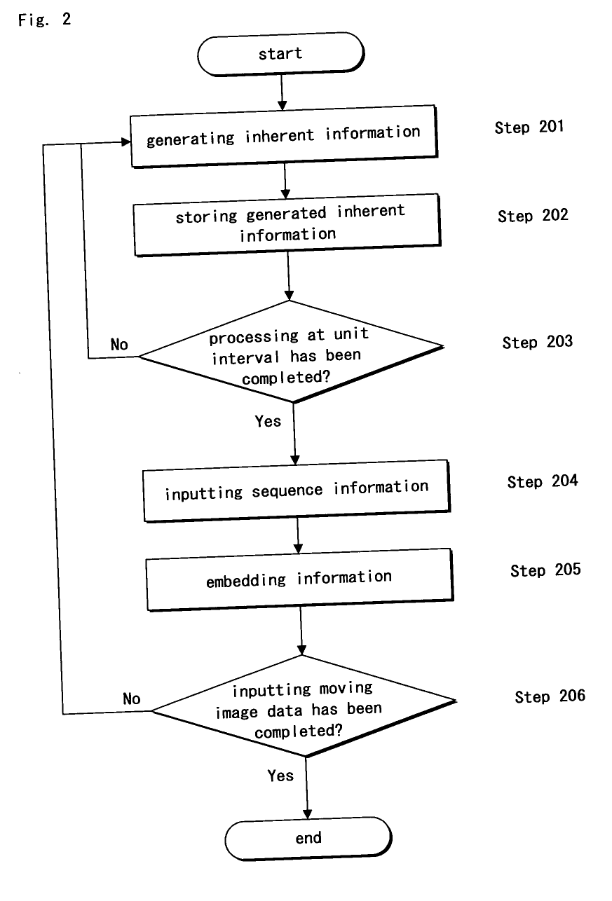

The information-embedding apparatus according to the present embodiment is further described with reference to FIG. 2. FIG. 2 is a flowchart illustrating behaviors of the information-embedding apparatus of FIG. 1. The present embodiment employs MPEG-compressed moving image data as moving image data in which tampering-detecting information is embedded. The MPEG-compressed moving image data includes an intra-coded image (I-picture), a forward predictive coded image (P-picture), and a bi-directionally predictive coded image (B-picture).

At step 201, the inherent information-generating unit 102 generates inherent information based on a frame image in the moving image data that has entered the information-embedding apparatus according to the present embodiment.

When the frame image is the I-picture (intra-coded image), then the inherent information-generating unit 102 generates inherent information (inherent information “I”), using a hash function, based on values of all frequency components, except for frequency components in which the digital watermarks are to be embedded, among frequency components at all blocks that form the frame image.

When the frame image is the P- or B-picture (predictive coded image), then the inherent information-generating unit 102 generates inherent information (inherent information “BP”), using the hash function, based on frequency components at all blocks in all of the P- or B-pictures covered by a unit interval.

Pursuant to the present embodiment, each of the unit intervals on the temporal axis refers to an interval between an I-picture and an image immediately before the next I-picture in the order in which frame images are accumulated. Alternatively, an interval between frame images that belong to a GOP (group of pictures) may be considered as the unit interval.

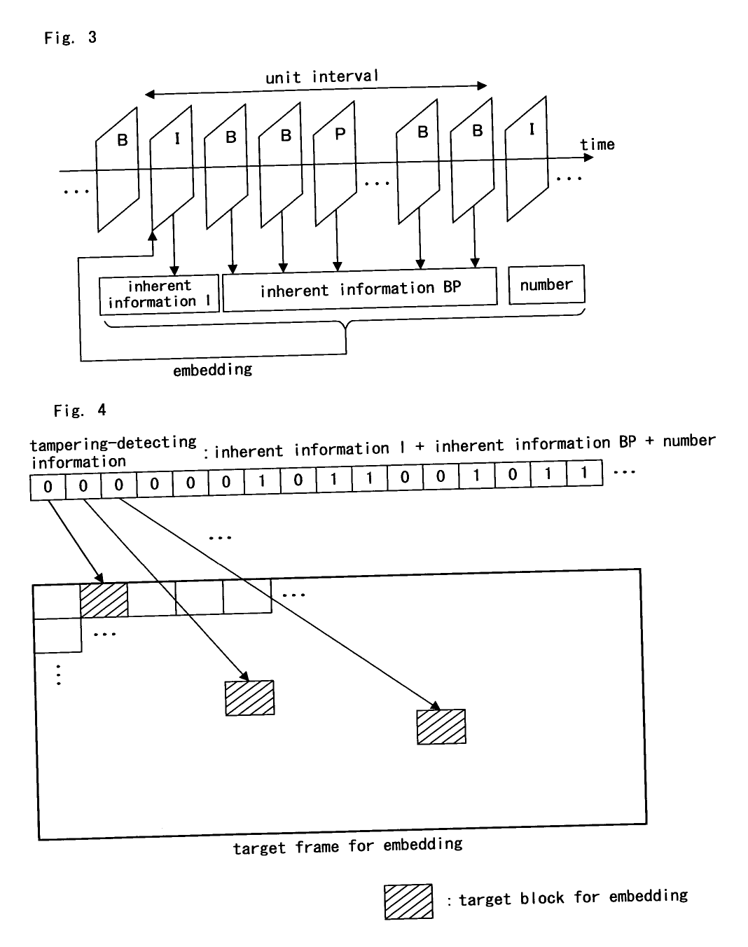

Each of inherent information “I”, “BP” has 128-bit data. FIG. 3 is an illustration showing a relationship between the inherent information and target pictures, from which the inherent information is generated.

At step 202, the inherent information-storing unit 103 stores the generated inherent information as discussed above.

At step 203, the sequence information input unit 101 determines whether the above processing at the unit interval has been completed. When the determination in step 203 results in “YES”, then the routine is advanced to step 204, at which the sequence information input unit 101 feeds sequence information into the information-embedding unit 104 in accordance with predetermined rules. Pursuant to the present embodiment, the sequence information uses numbers such as 0, 1, 2, etc. which are incremented by the amount of 1 (one). The sequence information has 16-bit data.

The information-embedding unit 104 handles a combination of the stored inherent information “I”, “BP” and the supplied sequence information as tampering-detecting information. As illustrated in FIG. 3, at step 205, the information-embedding unit 104 embeds the tampering-detecting information as a digital watermark into the I-picture at the head of the unit interval.

The following discusses, with reference to FIG. 4, the way in which the tampering-detecting information is embedded. FIG. 4 is an illustration showing how the tampering-detecting information is allocated to each block. FIG. 4 illustrates each rectangular block within a target frame in which the tampering-detecting information is to be embedded. The rectangular block is formed by eight-by-eight pixels.

The tampering-detecting information according to the present embodiment has the inherent information (I, BP) and numbers simply linked together, and consequently has a total of 272-bits.

The information-embedding unit 104 selects blocks equal in number to the bits of the tampering-detecting information. The selected blocks are handled as target blocks in which the tampering-detecting information is to be embedded. In FIG. 4, the target blocks are designated by hatched rectangles. The information-embedding unit 104 allocates the tampering-detecting information by one bit to each of the selected blocks.

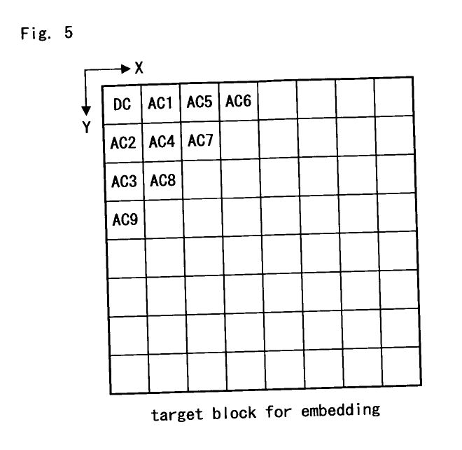

FIG. 5 is an illustration showing frequency components obtained for one of the target blocks in which the tampering-detecting information is to be embedded. The information-embedding unit 104 selects one of the frequency components of the target block, and then embeds the allocated bit into the selected frequency component. Pursuant to the present embodiment, the information-embedding unit 104 selects frequency component “AC3” of FIG. 5. When the allocated bit is “0”, then the information-embedding unit 104 changes the value of frequency component “AC3” into an even number. When the allocated bit is “1”, then the information-embedding unit 104 changes the value of frequency component “AC3” into an odd number.

At the final step 206, the information-embedding unit 104 determines whether the input of the frame images to be processed in the moving image data has been completed. When the determination in step 206 results in “YES”, then the routine is terminated, or otherwise is returned to step 201.

### SECOND EMBODIMENT

Pursuant to a second embodiment, moving image data having tampering-detecting information embedded therein as a digital watermark in accordance with the previous embodiment is examined to detect the embedded tampering-detecting information in order to check for tampered data.

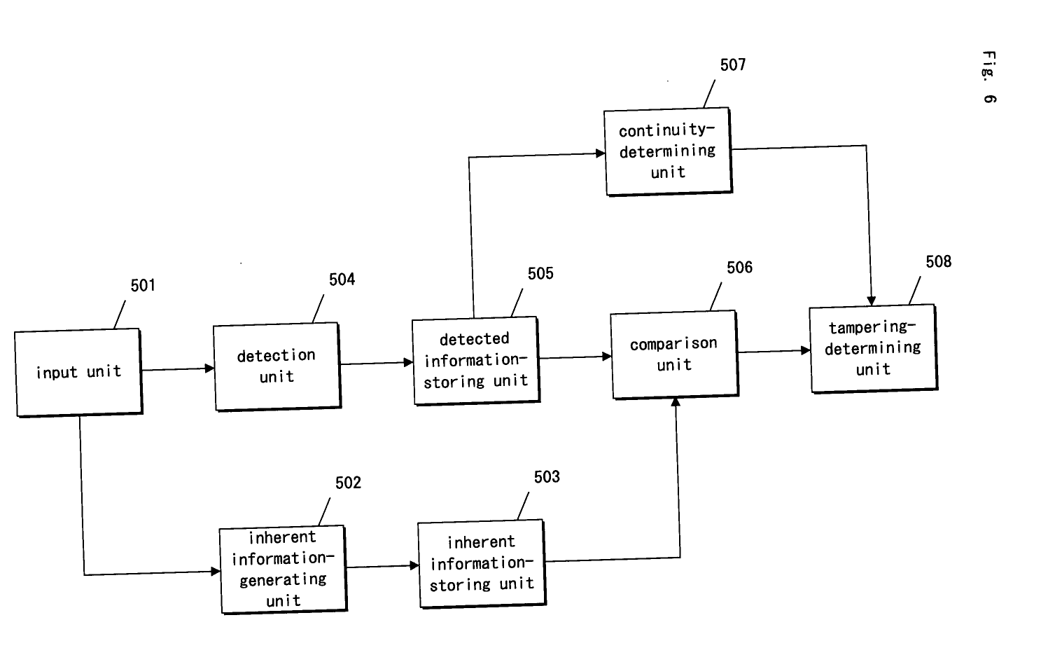

The present embodiment is now described with reference to the drawings. FIG. 6 is a block diagram illustrating a tampering-detecting apparatus according to the present embodiment.

As illustrated in FIG. 6, the tampering-detecting apparatus comprises an input unit 501, an inherent information-generating unit 502, an inherent information-storing unit 503, a detection unit 504, a detected information-storing unit 505, a comparison unit 506, a continuity-determining unit 507, and a tampering-determining unit 508.

The moving image data having sequence information embedded therein enters the input unit 501. The detection unit 504 is operable to detect sequence information from the moving image data received by the input unit 501. The detected information-storing unit 505 is operable to store the detected sequence information.

The continuity-determining unit 507 is operable to determine, based on the stored sequence information, whether frame images have continuity retained. More specifically, the continuity-determining unit 507 determines that the frame images have no continuity, when the frame images are changed in sequence, and/or when one or more frame images are removed or added to the frame images, or otherwise the continuity-determining unit 507 determines that the frame images have the continuity.

The tampering-determining unit 508 is operable to determine, based on results from the determination according to the continuity-determining unit 507, whether the moving image data has been tampered with.

The inherent information-generating unit 502 is operable to examine the moving image data, which has received by the input unit 501, to detect inherent information embedded in a specific frame image among plural frame images, thereby providing the first inherent information. Furthermore, the inherent information-generating unit 502 is operable to generate inherent information on either a single or multiple frame images among the plural frame images, thereby providing the second inherent information. The single or multiple frame images are temporally aligned in a given relationship with the specific frame image. The single or multiple frame images differ from the specific frame image. The inherent information-storing unit 503 stores the first and second inherent information.

The comparison unit 506 is operable to compare the stored first inherent information with the stored second inherent information. The tampering-determining unit 508 is operable to determine, based on results from the comparison according to the comparison unit 506, whether the moving image data has dishonestly been altered.

When the comparison result that the first and second inherent information agree with each other is fed into the tampering-determining unit 508 from the comparison unit 506, then the tampering-determining unit 508 determines that the moving image data remains intact.

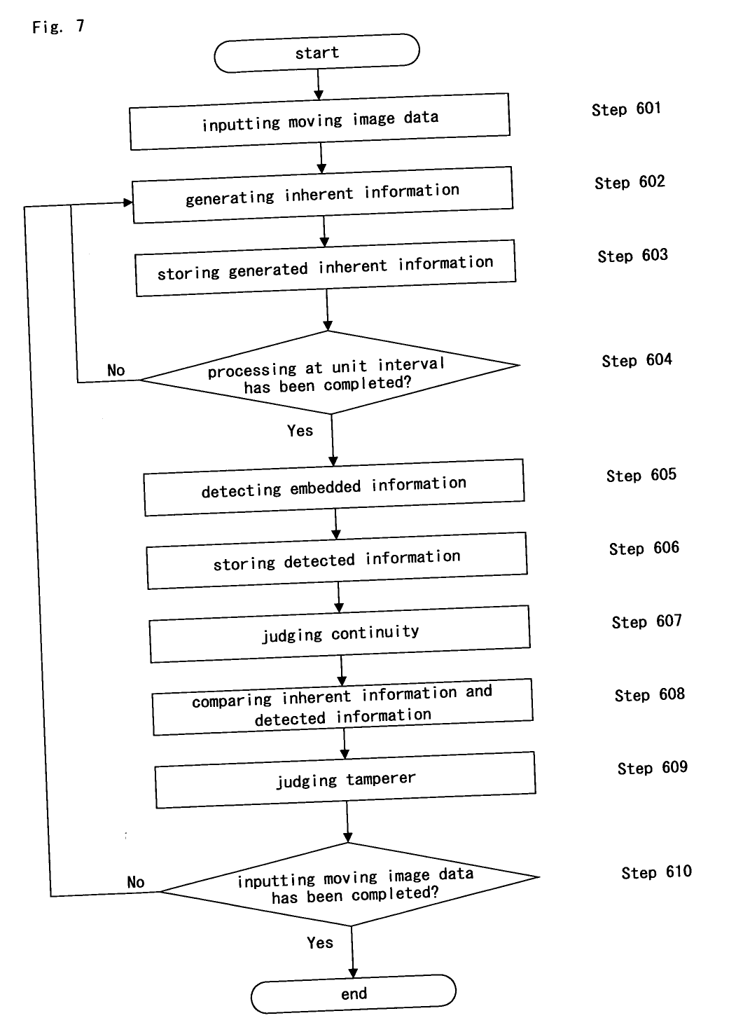

The tampering-detecting apparatus according to the present embodiment is further described with reference to FIG. 7. FIG. 7 is a flowchart illustrating behaviors of the tampering-detecting apparatus of FIG. 6.

At step 601, frame images enter the input unit 501. The frame images form the moving image data having tampering-detecting information embedded therein.

At step 602, the inherent information-generating unit 502 generates inherent information based on the received frame images. The processing at step 602 is the same as that at step 201 according to the previous embodiment as illustrated in FIG. 2, and descriptions related thereto are omitted.

At step 603, the inherent information-storing unit 503 stores the generated inherent information as discussed above.

At step 604, the inherent information-generating unit 502 determines whether the processing at a unit interval has been completed. When the determination in step 604 results in “YES”, then the routine is advanced to step 605, at which the detection unit 504 detects the embedded information from an I-picture at the head of the unit interval. The inherent information-generating unit 502 selects target blocks in which the tampering-detecting information has been embedded, in the same manner as the way in which the target blocks are selected to embed the tampering-detecting information into the selected target blocks.

The inherent information-generating unit 502 detects the embedded information from each of the selected blocks using bit values “0” and “1”. The bit value “0” is used when a frequency component selected to embed the information into each of the target blocks has a value expressed by an even number. The bit value “1” is used when the similarly selected frequency component has a value expressed by an odd number. In brief, the inherent information-generating unit 502 practices processing in a manner reverse to that at step 205 according to the previous embodiment.

At step 606, the detected information-storing unit 505 stores the detected information (see step 605 for the detected information).

At step 607, the continuity-determining unit 507 checks bit strings against predetermined continuity rules to determine whether the bit strings are consecutive in sequence. The bit strings correspond to the numbers that are part of the stored information (see step 606 for the stored information). The continuity rules are the same as those used for embedding the tampering-detecting information into the moving image data. For example, when the numbers to be consecutive in sequence, which have been detected from the I-picture at an unit interval, are always incremented by one (i.e., 0, 1, 2, etc.), then the continuity-determining unit 507 determines that the bit strings have continuity, or otherwise determines that the bit strings have no continuity.

At step 608, the comparison unit 506 compares and checks first and second bit strings against third and fourth bit strings, respectively, thereby determining a differential therebetween. The first and second bit strings correspond to inherent information “I” and inherent information “BP”, respectively, both of which have been stored at step 603. The third and fourth bit strings correspond to inherent information “I” and inherent information “BP”, respectively, both of which are part of the detected information that has been stored at step 606.

At step 609, the tampering-determining unit 508 determines that the moving image data remains intact, when it is determined at step 607 that the bit strings have continuity, and when the differential determined at step 608 is zero, or otherwise the tampering-determining unit 508 determines that the moving image data has been altered dishonestly.

At the final step 610, the tampering-determining unit 508 determines whether the input of the frame images to be processed in the moving image data has been completed. When the determination in step 610 results in “YES”, then the routine is terminated, or otherwise is returned to step 601.

As described above, a combination of the information-embedding apparatus according to the previous embodiment and the tampering-detecting apparatus according to the present embodiment detects and checks the embedded sequence information against the continuity rules that are the same as those used to embed the sequence information into the moving image data. This structure makes it feasible to detect temporal tampering.

To embed the information into the moving image data, inherent information “BP” from the P- and B-pictures is embedded into another image or the I-picture. To detect the digital watermark from the moving image data, the inherent information “BP” generated in the same manner as the way in which inherent information “BP” is generated to embed the tampering-detecting information is compared and checked against the detected information. This structure makes it feasible to detect spatial tampering from the P- and B-pictures. Even when substantially few encoded blocks are present in the P- and B-pictures, the digital watermark may be embedded into the I-picture having all blocks encoded therein. This feature detects spatially tampered data from the P- and B-pictures.

Furthermore, inherent information from all of the P- and B-pictures within a unit interval is embedded into another image or the I-picture. This embedding makes it feasible to detect temporally tampered data from the “P”- and “B”-pictures. For example, assume that some of the “P”- and “B”-pictures are removed therefrom. As a result, it is found, when the digital watermarks are detected, that inherent information “BP” generated based on the partially removed “P”- and “B”-pictures differs from the detected information. Consequently, the presence of maliciously modified data is discoverable.

In addition, inherent information “I” from the I-picture or a target picture in which the tampering-detecting information is to be embedded is embedded into the I-picture. To detect the digital watermarks from the moving image data, inherent information “I” generated in the same manner as the way in which inherent information “I” is generated to embed the tampering-detecting information is compared and checked against the detected information. As a result, the spatial tampering of the I-picture itself is detectable from the single I-picture.

Although the present embodiment uses MPEG-encoded data as the moving image data, the present invention is not limited thereto, but is similarly applicable to, e.g., motion JPEG

In the information-embedding apparatus according to the previous embodiment, the tampering-detecting information is embedded as digital watermarks into the frequency components of the selected blocks that represent pixels. Alternatively, the tampering-detecting information may be added directly to the header portion 10 of the moving image data. For example, the tampering-detecting information may be added at step 205 to the extension area “10a” of the header portion 10 of the MPEG-encoded data as shown in FIG. 10, and in the tampering-detecting apparatus according to the present embodiment, the added information may be detected at step 605 from the extension area “10a”. As a result, the alternative provides the same beneficial effects as well.

Although the hash value having the 128-bits, calculated based on frequency components, is used as inherent information at step 201, the present invention is not limited thereto because the use of any information inherent to each image provides the same beneficial effects. Pursuant to the present invention, a piece of inherent information is generated based on all of the “P”- and “B”-pictures within a unit interval. Alternatively, a piece of inherent information may be generated based on each of the “P”- and “B”-pictures. As a further alternative, a piece of inherent information may be generated based on plural images. Pursuant to the present invention, an interval between an I-picture and an image immediately before the next I-picture in the order in which frame images are accumulated is handled as a unit interval. However, the present invention is not limited thereto.

Although the numbers having 16-bits in which numerals are incremented by one are used as continuity information at step 203, the present invention is not limited thereto, but is susceptible to the use of any information that represents continuity. In other words, any information may be used, which conforms to common rules used when the digital watermarks are both embedded and detected. More specifically, the information may be formed in alphabetical order instead of being formed by a series of numbers, or can be either characters in significant sentences or an appropriate numerical series.

The present invention illustrates the tampering detecting information-embedding method at step 205, in which one bit is allocated to each of the selected blocks, and which a frequency component at the selected block is changed. However, this is illustrated merely by way of one example. Any tampering detecting information-embedding method operable to suppress degradation in image quality and to exercise as little influence on the original moving image data as possible is preferred.

Although the tampering-detecting information is embedded at step 205 into the I-picture at the head of the unit interval, the present invention is not limited thereto. Alternatively, the tampering-detecting information may be embedded into either the “P”-picture or the “B”-picture, when possible.

Pursuant to the present embodiment, it is determined at step 609 that the moving image data remains intact, when the bit strings are determined at step 607 to have continuity, and when a differential determined at step 608 is zero. Alternatively, it may be determined that the moving image data remain intact, when the differential is equal or less than a threshold. The alternative makes it feasible to differentiate merely irreversible image transformation from malicious alternation.

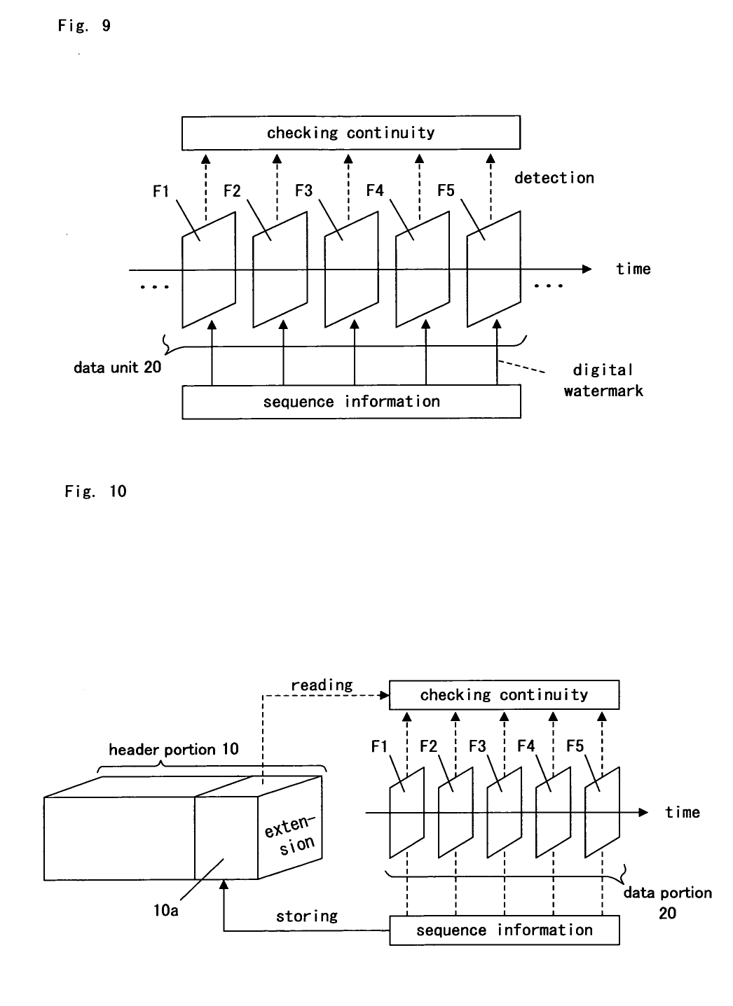

The previous and present embodiments are susceptible to further various modifications. The following discusses, with reference to FIGS. 9 to 14, further modes of embedding the tampering-detecting information and further modes of detecting the tampering.

### THIRD EMBODIMENT

FIG. 9 is a descriptive illustration showing an information-embedding mode and a tampering-detecting mode according to a third embodiment. Pursuant to the present embodiment, each piece of sequence information is embedded as a digital watermark into corresponding one of frame images “F1” to “F5” that form a data portion 20 of moving image data. To detect tampering, the embedded digital watermark is detected from each of frame images “F1” to “F5”, thereby obtaining the sequence information.

When an abnormality is found from the obtained sequence information, then it is determined that frame images “F1” to “F5” have temporally been tampered with, or otherwise it is determined that frame images “F1” to “F5” temporally remain intact.

### FOURTH EMBODIMENT

FIG. 10 is a descriptive illustration showing an information-embedding mode and a tampering-detecting mode according to a fourth embodiment.

The present embodiment differs from the third embodiment in terms of that sequence information on frame images “F1” to “F5” is contained in a header 10 at an extension area “10a” thereof to determine whether frame images “F1” to “F5” have maliciously been modified. Pursuant to the present embodiment, the sequence information is invisibly provided.

### FIFTH EMBODIMENT

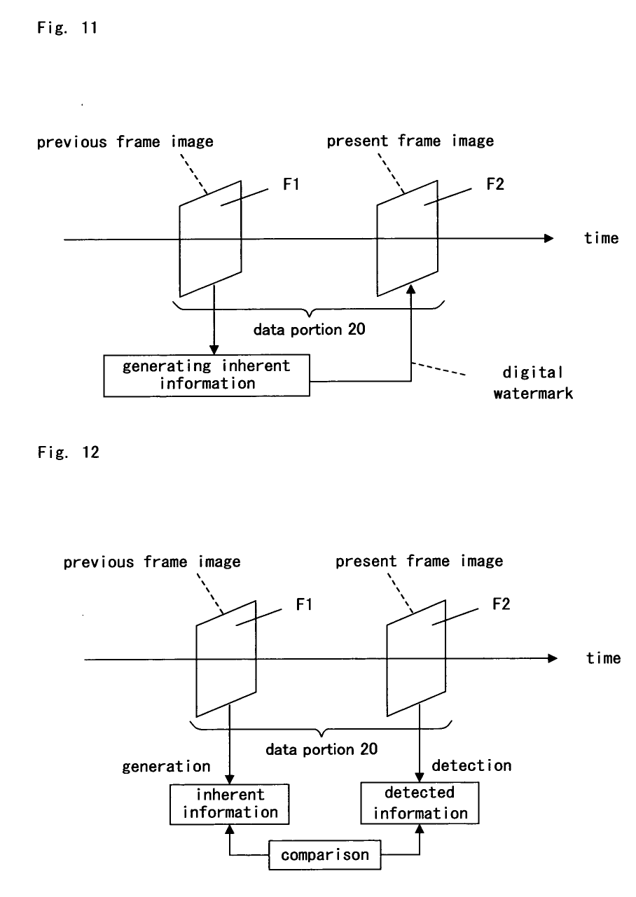

FIG. 11 is a descriptive illustration showing an information-embedding mode according to a fifth embodiment. FIG. 12 is a descriptive illustration showing a tampering-detecting mode according to the fifth embodiment.

As illustrated in FIG. 11, pursuant to the present embodiment, when attention is directed to a specific frame image or the present frame image “F2”, inherent information is generated based on another frame image or the previous frame image “F1” that is positioned temporally immediately before the present frame image “F2”. The generated inherent information is embedded as a digital watermark into the present frame “F2”.

As illustrated in FIG. 12, to detect malicious modification, the digital watermark embedded in the present frame image “F2” is detected therefrom, thereby obtaining the first inherent information.

Meanwhile, inherent information is generated based on the previous frame image “F1”, thereby providing the second inherent information.

The first inherent information is compared with the second inherent information. When the first and second inherent information are found to be equal to one another, then it is determined that the frame images temporally remain intact, or otherwise it is determined that the frame images have temporally been tampered with. The same relationship as above is established, even when a frame image itself has maliciously been altered (the first tampering). According to the present embodiment, the first and second tampering is detectable at a time.

The use of the first and second inherent information as described above forms a relationship in which the previous and present frame images “F1” and “F2” are virtually chain-combined together. When the relationship is repeatedly established between all frames, then all of the frames are chain-linked together. This structure is possible to cope with all temporally dishonest modifications because the temporal tampering always disconnects the chain linkage at a position somewhere, and because the disconnected chain linkage is easy to detect.

### SIXTH EMBODIMENT

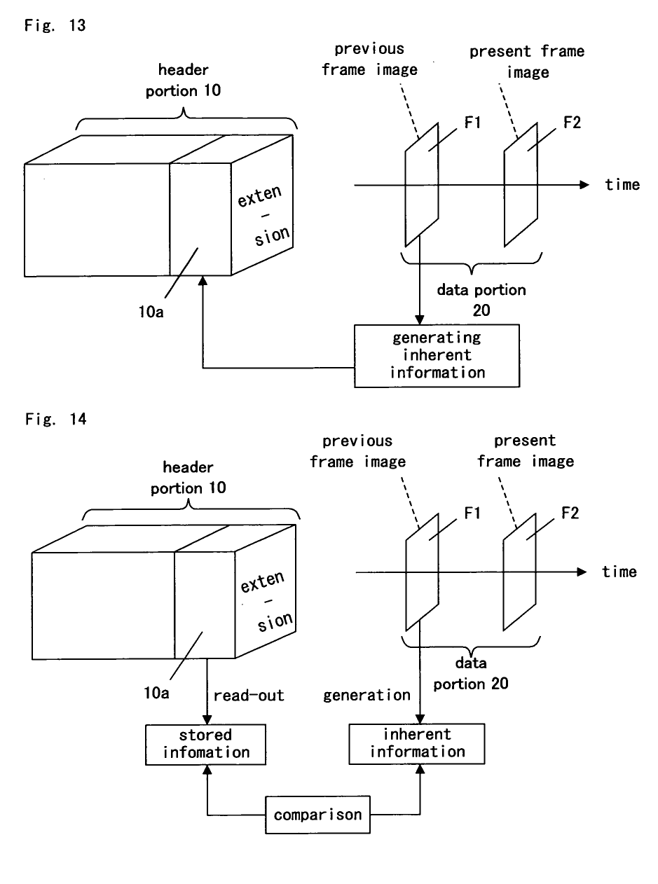

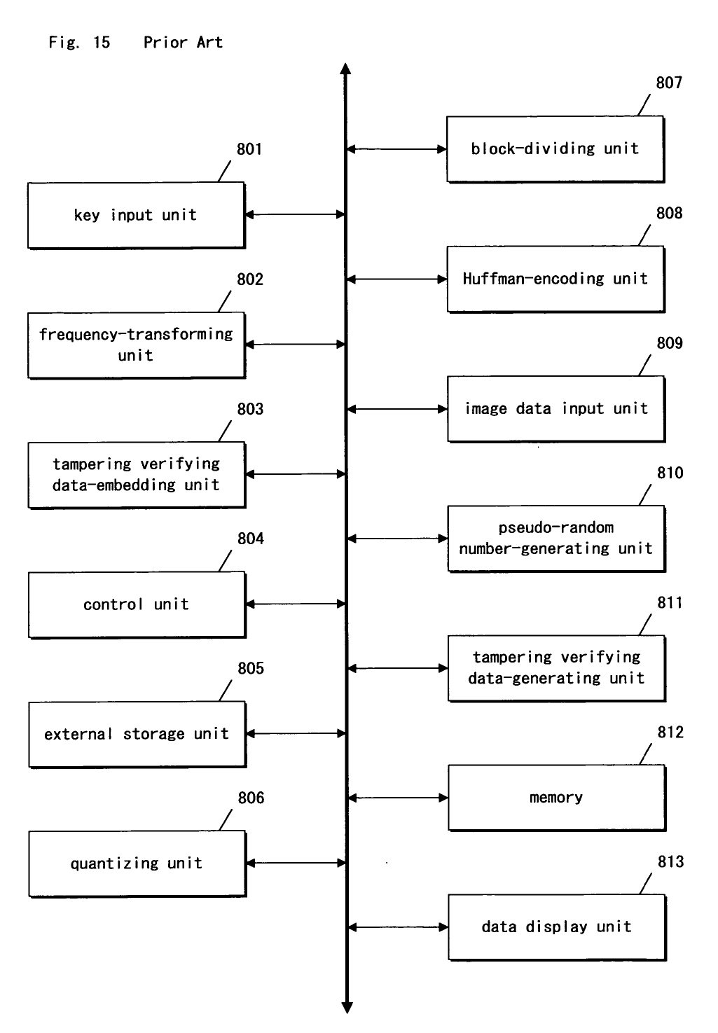

FIG. 13 is a descriptive illustration showing an information-embedding mode according to a sixth embodiment. FIG. 14 is a descriptive illustration showing a tampering-detecting mode according to the sixth embodiment.

The present embodiment differs from the fifth embodiment in terms of that inherent information is placed into a header portion 10 at an extension area “10a” thereof instead of being embedded as a digital watermark into each frame image. In short, the present embodiment has a relationship with the fifth embodiment in a manner similar to a relationship of the fourth embodiment with the third embodiment.

It is understood that the third to six embodiments may be practiced independently or in combination. At any rate, any selection from those embodiments is encompassed by the present invention.

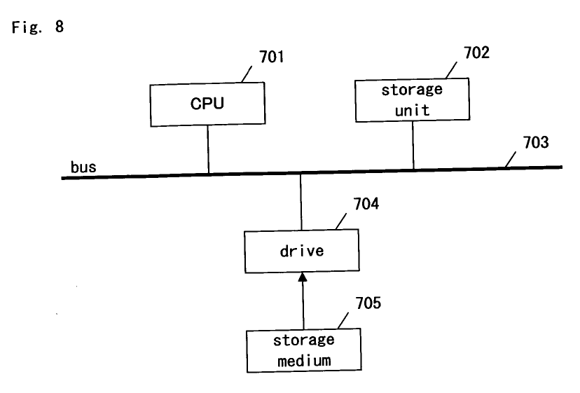

Typically, as illustrated in FIG. 8, features provided by the information-embedding apparatus and tampering-detecting apparatus according to the first and second embodiments are realized by a storage unit 702 (a ROM, a RAM, and a hard disc), which contains predetermined program data, and a CPU701 (central-processing unit) that executes the program data. The program data may be introduced using a storage medium 705 such as a CD-ROM and a flexible disc.

Pursuant to the present invention, the temporal tampering is detectable.

The spatial tampering as well as the temporal tampering is detectable.

The spatial tampering is detectable, even with a predictive coded image in which encoded blocks are absent. Furthermore, the spatial tampering of an intra-image is detectable from the single intra-image.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. An information-embedding apparatus operable to embed information into moving image data that includes a data portion and a header portion, the data portion being formed to temporally align plural frame images with each other in sequence, the header portion being designed to retain information on the data portion, said information-embedding apparatus comprising:
a sequence information input unit operable to generate sequence information on the plural frame images; and
an information-embedding unit operable to embed the sequence information generated by said sequence information input unit into the moving image data over the plural frame images in such a manner as to render the sequence information invisible.

2. An information-embedding apparatus as defined in claim 1, wherein said information-embedding unit is operable to embed the sequence information as a digital watermark into the data portion.

3. An information-embedding apparatus as defined in claim 1, wherein said information-embedding unit is operable to embed the sequence information into the header portion.

4. An information-embedding apparatus as defined in claim 1, wherein the sequence information refers to numbers that show sequence of the plural frame images.

5. A tampering-detecting apparatus operable to check for tampering in moving image data that includes a data portion and a header portion, the data portion being formed to temporally align plural frame images with each other in sequence, the header portion being designed to retain information on the data portion, said tampering-detecting apparatus comprising:
an input unit operable to receive the moving image data having sequence information embedded therein;
a detection unit operable to detect the sequence information from the moving image data received by said input unit; and
a tampering-determining unit operable to determine, based on the sequence information detected by said detection unit, whether the moving image data has been tampered with.

6. A tampering-detecting apparatus as defined in claim 5, wherein the sequence information refers to numbers that show sequence of the plural frame images.

7. A tampering-detecting apparatus as defined in claim 5, wherein said tampering-determining unit is operable to determine that the moving image data has been tampered with, when the plural frame images are changed in sequence, and when one or more frame images are removed or added to the plural frame images.

8. An information-embedding apparatus operable to embed information into moving image data that includes a data portion and a header portion, the data portion being formed to temporally align plural frame images with each other in sequence, the header portion being designed to retain information on the data portion, said information-embedding apparatus comprising:
an inherent information-generating unit operable to generate inherent information on a first frame image among the plural frame images, the first frame image being temporally aligned in a given relationship with a second frame image among the plural frame images, the first frame image being one of a single and multiple frame images among the plural frame images, and the single and the multiple frame images being different from the second frame image; and
an information-embedding unit operable to embed the inherent information generated by said inherent information-generating unit into the second frame image.

9. An information-embedding apparatus as defined in claim 8, wherein the inherent information is a hash value related to the first frame image.

10. An information-embedding apparatus as defined in claim 8, wherein the first frame image is temporally positioned next to the second frame image.

11. An information-embedding apparatus as defined in claim 8, wherein the moving image data is MPEG-compressed moving image data, the second frame image is an intra-coded image, and the first frame image is one of a single and multiple predictive coded images.

12. An information-embedding apparatus as defined in claim 11, wherein the intra-coded image and the predictive coded images belong to a GOP (group of pictures).

13. A tampering-detecting apparatus operable to check for tampering in moving image data that includes a data portion and a header portion, the data portion being formed to temporally align plural frame images with each other in sequence, the header portion being designed to retain information on the data portion, said tampering-detecting apparatus comprising:
an input unit operable to receive the moving image data having sequence information embedded therein;
an inherent information-generating unit operable to detect, from the moving image data received by said input unit, inherent information embedded in a second frame image among the plural frame images, thereby providing first inherent information;
said inherent information-generating unit operable to generate inherent information on a first frame image among the plural frame images, thereby providing second inherent information, the first frame image being temporally aligned in a given relationship with the second frame image, the first frame image being one of a single and multiple frame images among the plural frame images, and the single and multiple frame images being different from the second frame image;
a comparison unit operable to compare the first inherent information with the second inherent information; and
a tampering-determining unit operable to determine, based on results from a comparison made by said comparison unit, whether the moving image data has been tampered with.

14. A tampering-detecting apparatus as defined in claim 13, wherein said tampering-determining unit determines that the moving image data remains intact, when the first inherent information agrees with the second inherent information.

15. A tampering-detecting apparatus as defined in claim 13, wherein the inherent information is a hash value related to the first frame image.

16. A tampering-detecting apparatus as defined in claim 13, wherein the first frame image is temporally positioned next to the second frame image.

17. A tampering-detecting apparatus as defined in claim 13, wherein the moving image data is MPEG-compressed moving image data, the second frame image is an intra-coded image, and the first frame image is one of a single and multiple predictive coded images.

18. A tampering-detecting apparatus as defined in claim 17, wherein the intra-coded image and the predictive coded images belong to a GOP (group of pictures).

19. A tampering-detecting method comprising: checking for tampering in moving image data that includes a data portion and a header portion, the data portion being formed to temporally align plural frame images with each other in sequence, the header portion being designed to retain information on the data portion;
embedding sequence information on the plural frame images into the moving image data over the plural frame images in such a manner as to render the sequence information invisible;
detecting the sequence information from the moving image data; and
determining, based on the detected sequence information, whether the moving image data has been tampered with.

20. A tampering-detecting method comprising:
checking for tampering in moving image data that includes a data portion and a header portion, the data portion being formed to temporally align plural frame images with each other in sequence, the header portion being designed to retain information on the data portion;
generating inherent information on a first frame image among the plural frame images, the first frame image being temporally aligned in a given relationship with a second frame image among the plural frame images;
embedding the generated inherent information into the second frame image;
detecting the embedded inherent information from the second frame image, thereby providing first inherent information;
generating inherent information on the first frame image, thereby providing second inherent information;
comparing the first inherent information with the second inherent information; and
determining, based on results of said comparing, whether the moving image data has been tampered with.

21. An information-embedding method comprising:
embedding information into moving image data that includes a data portion and a header portion, the data portion being formed to temporally align plural frame images with each other in sequence, the header portion being designed to retain information on the data portion; and
embedding sequence information on the plural frame images into the moving image data over the plural frame images in such a manner as to render the sequence information invisible.

22. A tampering-detecting method comprising:
checking for tampering in moving image data that includes a data portion and a header portion, the data portion being formed to temporally align plural frame images with each other in sequence, the header portion being designed to retain information on the data portion;
entering the moving image data having sequence information embedded therein;
detecting the sequence information from the entered moving image data; and
determining, based on the detected sequence information, whether the moving image data has been tampered with.

23. An information-embedding method comprising:
embedding information into moving image data that includes a data portion and a header portion, the data portion being formed to temporally align plural frame images with each other in sequence, the header portion being designed to retain information on the data portion;
generating inherent information on a first frame image among the plural frame images, the first frame image being temporally aligned in a given relationship with a second frame image among the plural frame images, the first frame image being one of a single and multiple frame images among the plural frame images, and the single and multiple frame images being different from the second frame image; and
embedding the generated inherent information into the second frame image.

24. A tampering-detecting method comprising: checking for tampering in moving image data that includes a data portion and a header portion, the data portion being formed to temporally align plural frame images with each other in sequence, the header portion being designed to retain information on the data portion;
entering the moving image data having sequence information embedded therein;
detecting inherent information embedded in a second frame image among the plural frame images, thereby providing first inherent information;
generating inherent information on a first frame image among the plural frame images, thereby providing second inherent information, the first frame image being temporally aligned in a given relationship with the second frame image, the first frame image being one of a single and multiple frame images among the plural frame images, and the single and multiple frame images being different from the second frame image;
comparing the first inherent information with the second inherent information; and
determining, based on results of said comparing, whether the moving image data has been tampered with.

25. A recording medium containing a processing program in a computer readable manner, the processing program being operable to realize the information-embedding method as defined in claim 21.
